(19) United States
(12) Patent Application Publication
(10) Pub. No.: US 2012/0160269 A1
(43) Pub. Date: Jun. 28, 2012

(54) REFRESH WASHING MACHINE AND CONTROL METHOD THEREOF

(75) Inventors: Sang Yeon Pyo, Suwon-si (KR); Ki Soo Kim, Gunpo-si (KR); Sang Min Hyun, Seoul (KR)

(73) Assignee: Samsung Electronics Co., Ltd., Suwon-si (KR)

(21) Appl. No.: 13/337,907

(22) Filed: Dec. 27, 2011

(30) Foreign Application Priority Data
Dec. 28, 2010 (KR) 10-2010-0136430

(51) Int. Cl. D06F 17/12; B08B 5/02

(52) U.S. Cl. 134/18; 68/5 C; 134/25.1

(57) ABSTRACT

A refresh washing machine including a plurality of spray nozzles to spray air into a clothes receiving compartment of a cabinet, a plurality of opening and closing valves to open and close the spray nozzles, and a controller to open at least one of the opening and closing valves and close the other opening and closing valves so that air is sequentially sprayed from the spray nozzles.

### CROSS-REFERENCE TO RELATED APPLICATIONS

This application claims the benefit of Korean Patent Application No. 10-2010-0136430, filed on Dec. 28, 2010 in the Korean Intellectual Property Office, the disclosure of which is incorporated herein by reference.

### BACKGROUND

1. Field

Embodiments of the present disclosure relate to a refresh washing machine that refreshes clothes using air.

2. Description of the Related Art

A refresh washing machine includes a washing machine to wash clothes, a drying machine to dry wet clothes, and a refreshing machine to refresh clothes.

The refresh washing machine supplies hot air or steam into a clothing receiving space to dry or refresh the clothes. However, dust separated from the clothes may be adsorbed by the clothes with the result that the dust may not be efficiently removed.

### SUMMARY

It is an aspect of the present disclosure to provide a refresh washing machine to effectively remove dust through an improved air spray (or circulation) structure.

Additional aspects of the disclosure will be set forth in part in the description which follows and, in part, will be apparent from the description, or may be learned by practice of the disclosure.

In accordance with an aspect of the present disclosure, a refresh washing machine includes a cabinet having a clothes receiving compartment, a plurality of spray nozzles to spray air into the clothes receiving compartment of the cabinet, a plurality of opening and closing valves to open and close the spray nozzles, and a controller to open at least one of the opening and closing valves and close the other opening and closing valves so that air is sequentially sprayed from the spray nozzles.

The refresh washing machine may further include an exhaust port through which air is discharged from the clothes receiving compartment of the cabinet, wherein the spray nozzles may sequentially spray air from one most distant from the exhaust port to one closest to the exhaust port.

The spray nozzles may sequentially spray air from the uppermost one to the lowermost one in a case in which the exhaust port is located at the lower side of the cabinet.

The spray nozzles may be inclined downward.

The spray nozzles may sequentially spray air from the lowermost one to the uppermost one in a case in which the exhaust port is located at the upper side of the cabinet.

The spray nozzles may be inclined upward.

The refresh washing machine may further include a dust tank connected to the exhaust port to store dust.

The refresh washing machine may further include an air pump connected to the dust tank to suction air.

The refresh washing machine may further include a spray duct connected to the nozzles and an air pump connected to the spray duct.

The refresh washing machine may further include a steam supply unit to supply steam into the clothes receiving compartment of the cabinet.

In accordance with another aspect of the present disclosure, a refresh washing machine includes a cabinet having a clothes receiving compartment and at least one nozzle exposed in the clothes receiving compartment of the cabinet, wherein the at least one nozzle includes a spray nozzle to spray air into the clothes receiving compartment of the cabinet and an exhaust nozzle to discharge air from the clothes receiving compartment of the cabinet.

The refresh washing machine may further include an opening and closing valve to open and close the spray nozzle.

The at least one nozzle may include a plurality of nozzles.

The refresh washing machine may further include a spray duct connected to the spray nozzle and an air pump connected to the spray duct.

The refresh washing machine may further include an exhaust duct connected to the exhaust nozzle and a dust tank connected to the exhaust duct.

The exhaust nozzle may surround an outer circumference of the spray nozzle.

In accordance with a further aspect of the present disclosure, a control method of a refresh washing machine including a plurality of spray nozzles to spray air into a clothes receiving compartment and a plurality of opening and closing valves to open and close the spray nozzles includes controlling the opening and closing valves so that air is sequentially sprayed from the spray nozzles.

The refresh washing machine may further include an exhaust port through which air is discharged from the clothes receiving compartment and a dust sensor to sense dust passing through the exhaust port, and the control method may further include adjusting spray pressure or spray frequency of air sprayed into the clothes receiving compartment based on information from the dust sensor.

The control method may further include increasing the air spray pressure or the air spray frequency when a dust measurement value measured by the dust sensor exceeds a reference value.

The control method may further include decreasing the air spray pressure or the air spray frequency when the dust measurement value is less than the reference value.

The refresh washing machine may further include an exhaust port through which air is discharged from the clothes receiving compartment, and the control method may further include controlling the spray nozzles to sequentially spray air from one most distant from the exhaust port to one closest to the exhaust port.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating the external structure of a refresh washing machine according to an embodiment of the present disclosure;

FIG. 2 is a sectional view illustrating the internal structure of the refresh washing machine according to the embodiment of the present disclosure;

FIG. 3 is a view illustrating the early operation of the refresh washing machine according to the embodiment of the present disclosure;

FIG. 4 is a view illustrating the middle operation of the refresh washing machine according to the embodiment of the present disclosure;

FIG. 5 is a view illustrating the final operation of the refresh washing machine according to the embodiment of the present disclosure;

FIG. 6 is a sectional view illustrating the internal structure of a refresh washing machine according to another embodiment of the present disclosure;

FIG. 7 is a view illustrating a series of operations of the refresh washing machine according to the embodiment of the present disclosure;

FIG. 8 is a sectional view illustrating the internal structure of a refresh washing machine according to a further embodiment of the present disclosure;

FIG. 9 is a view illustrating the early operation of the refresh washing machine according to the embodiment of the present disclosure;

FIG. 10 is a view illustrating the middle operation of the refresh washing machine according to the embodiment of the present disclosure; and

FIG. 11 is a perspective view illustrating the final operation of the refresh washing machine according to the embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

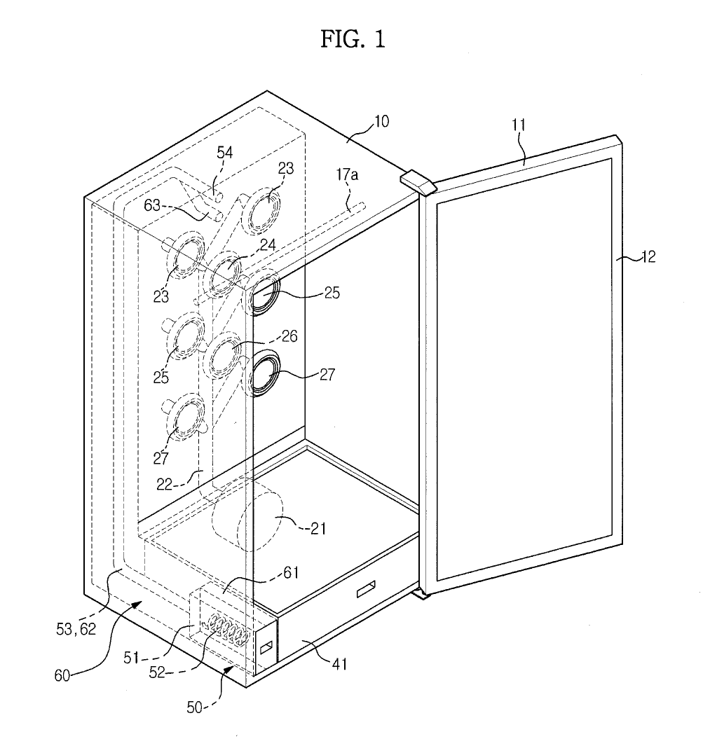

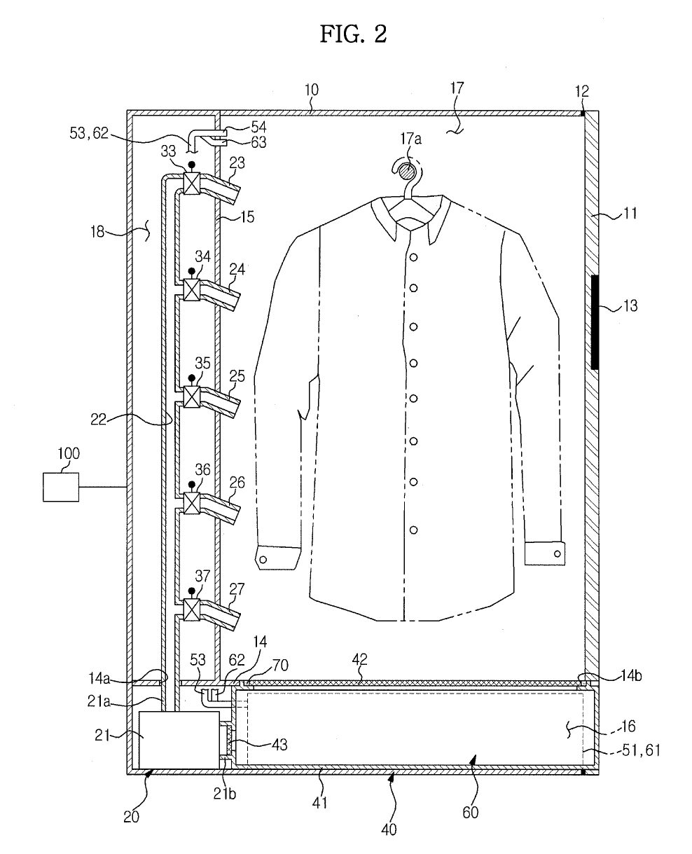

FIG. 1 is a perspective view illustrating the external structure of a refresh washing machine according to an embodiment of the present disclosure, and FIG. 2 is a sectional view illustrating the internal structure of the refresh washing machine according to the embodiment of the present disclosure.

As shown in FIGS. 1 and 2, the refresh washing machine may include a cabinet 10, an air supply unit 20, a dust separation unit 40, a steam supply unit 50, an aromatic supply unit 60 and a dehumidification unit (not shown).

A door 11 is mounted at the front of the cabinet 10. The door 11 may be opened to access the interior of the cabinet 10. At the door 11 is mounted a gasket (or damper) 12 extending along a portion of the door 11 contacting the cabinet 10. The gasket 12 interrupts flow of air between the door 11 and the cabinet 10. Also, a display 13 to display operation information is provided at the door 11.

The interior of the cabinet 10 is partitioned into a plurality of spaces by partitions 14 and 15. The first partition 14 is mounted in the lateral direction of the cabinet 10 to partition the interior of the cabinet 10 in the vertical direction. A machine compartment 16 is provided below the first partition 14. An air pump 21, a dust tank 41, a water tank 51 and an aromatic tank 61 may be mounted in the machine compartment 16. The second partition 15 is mounted in the vertical direction of the cabinet 10 to partition the interior of the cabinet 10 in the horizontal direction. A clothes receiving compartment 17 is provided at the right side of the cabinet 10, and a duct compartment 18 is provided at the left side of the cabinet 10. Clothes are received in the clothes receiving compartment 17. In the duct compartment 18 is mounted a spray duct 22 to guide air. Also, a holder 17a to hold clothes is mounted in the clothes receiving compartment 17.

Meanwhile, a spray port 14a, through which the machine compartment 16 and the duct compartment 18 communicate, and an exhaust port 14b, through which the clothes receiving compartment and the machine compartment 16 communicate, are formed at the first partition 14. The spray duct 22 is connected to the spray port 14a of the first partition 14, and the dust tank 41 is connected to the exhaust port 14b of the first partition 14.

The air supply unit 20 may include an air pump 21, a spray duct 22, a plurality of nozzles 23 to 27 and a plurality of opening and closing valves 33 to 37.

The air pump 21 is mounted in the machine compartment 16. An air discharge part 21a of the air pump 21 is connected to the spray duct 22 through the spray port 14a of the first partition 14. An air suction part 21b of the air pump 21 is connected to the dust tank 41.

The spray duct 22 is mounted in the duct compartment 18. The spray duct 22 has branches corresponding to the nozzles 23 to 27. The nozzles 23 to 27 are connected to ends of the branches of the spray duct 22.

The nozzles 23 to 27 are mounted at the second partition 15 so that at least a portion of each of the nozzles 23 to 27 is exposed in the clothes receiving compartment 17. The nozzles 23 to 27 are downwardly inclined to the door 11. Consequently, air is sprayed downward from the nozzles 23 to 27 in an inclined state. Spray holes may be formed at the respective nozzles 23 to 27.

The opening and closing valves 33 to 37 allow air sprayed from the nozzles 23 to 27 to flow therethrough and interrupt such flow of air. A controller 100 controls the opening and closing valves 33 to 37 so that the nozzles 23 to 27 are sequentially operated. That is, air is sequentially sprayed from the nozzles 23 to 27. For example, air is first sprayed from the first nozzle 23 disposed at the uppermost side of the first partition 14, air is sprayed from the second nozzle 24 below the first nozzle 23, the third nozzle 25 below the second nozzle 24 and the fourth nozzle 26 below the third nozzle 25 in order, and air is finally sprayed from the fifth nozzle 27 disposed at the lowermost side of the first partition 14.

The dust separation unit 40 may include a dust tank 41, an exhaust port 14b, a first filter 42 and a second filter 43. The dust separation unit 40 separates and stores foreign matter, such as dust removed from clothes, from air.

The dust tank 41 is detachably mounted in the machine compartment 16. The dust tank 41 is connected to the exhaust port 14b. The first filter 42 is mounted in the exhaust port 14b. Also, the dust tank 41 is connected to the air suction part 21b of the air pump 21. The second filter 43 is mounted in this connection part. Microscopic dust passes through the first filter and is introduced into the dust tank 41; however, the microscopic dust does not pass through the second filter with the result that the microscopic dust is stored in the dust tank 41.

In another embodiment, on the other hand, the dust tank 41 may not be connected to the air suction part 21 b of the air pump 21 but to an additional exhaust pump (not shown). In this case, the air pump 21 is used to spray air into the clothes receiving compartment 17, and the exhaust pump is used to discharge air from the clothes receiving compartment 17.

The exhaust port 14b is formed at the first partition 14. The clothes receiving compartment 17 and the dust tank 41 communicate with each other through the exhaust port 14b. Air containing dust is introduced into the dust tank 41 from the clothes receiving compartment 17 through the exhaust port 14b. In the exhaust port 14b is mounted a dust sensor 70 to sense the introduction of dust. The dust sensor 70 may be an optical sensor or an ultrasonic sensor. The controller 100 may control air spray pressure or air spray frequency based on the amount of dust sensed by the dust sensor 70. For example, when a dust measurement value of the dust sensor 70 exceeds a reference value, the controller 100 determines that a large amount of dust is attached to the clothes and increases air spray pressure or air spray frequency. On the other hand, when the dust measurement value of the dust sensor 70 is less than the reference value, the controller 100 determines that a small amount of dust is attached to, the clothes and decreases air spray pressure or air spray frequency.

The steam supply unit 50 may include a water tank 51, a heater 52, a steam duct 53 and a steam spray nozzle 54.

The water tank 51 is mounted in the machine compartment 16. The heater 52 is mounted in the water tank 51. The heater 52 heats water stored in the water tank 51 to generate steam. The steam flows to the steam spray nozzle 54 via the steam duct 53. The steam spray nozzle 54 sprays the steam into the clothes receiving compartment 17.

The aromatic supply unit 60 may include an aromatic tank 61, an aromatic duct 62 and an aromatic spray nozzle 63.

The aromatic tank 61 is mounted in the machine compartment 16 together with the water tank 51. An aromatic stored in the aromatic tank 61 flows to the aromatic spray nozzle 6 via the aromatic duct 62. The aromatic spray nozzle 63 sprays the aromatic into the clothes receiving compartment 17. The aromatic may remove unpleasant smells from the clothes receiving compartment 17 and provide fragrance to the clothes receiving compartment 17.

In addition, the refresh washing machine may further include a dehumidification unit. The dehumidification unit may include a heat pump. The dehumidification unit may remove moisture from the clothes receiving compartment 17.

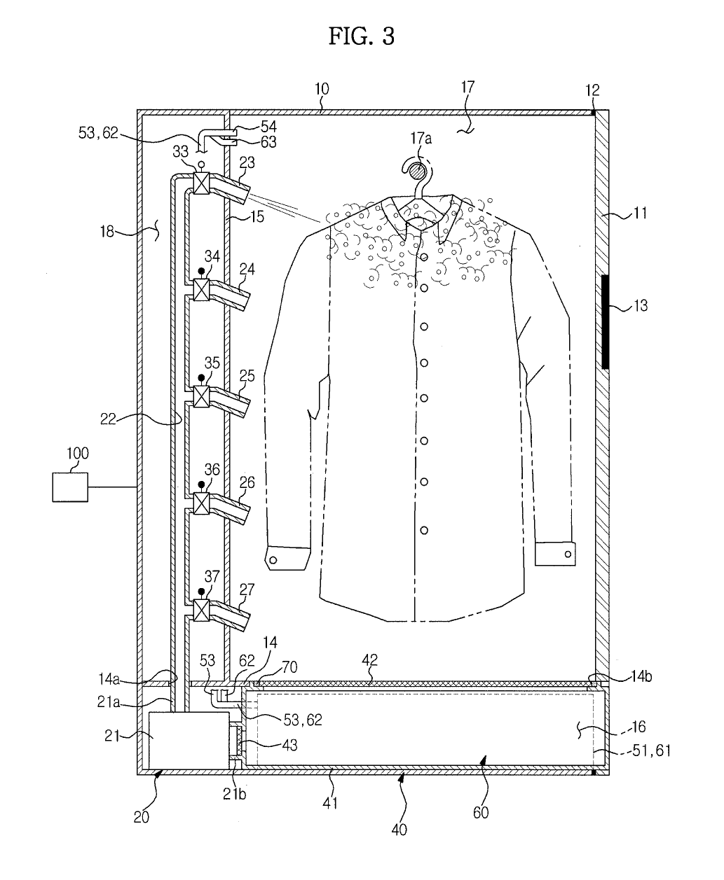

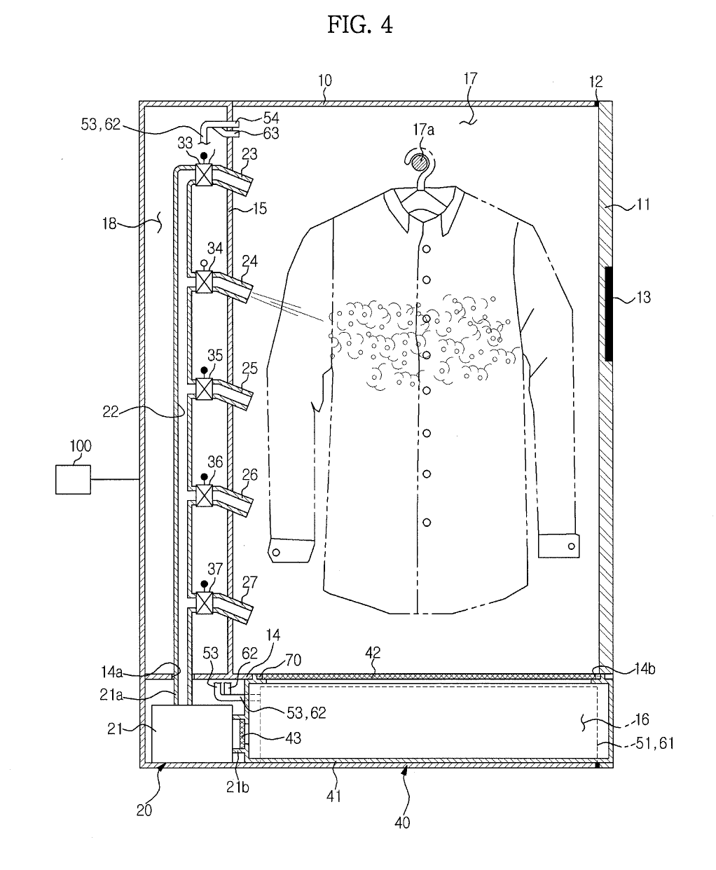

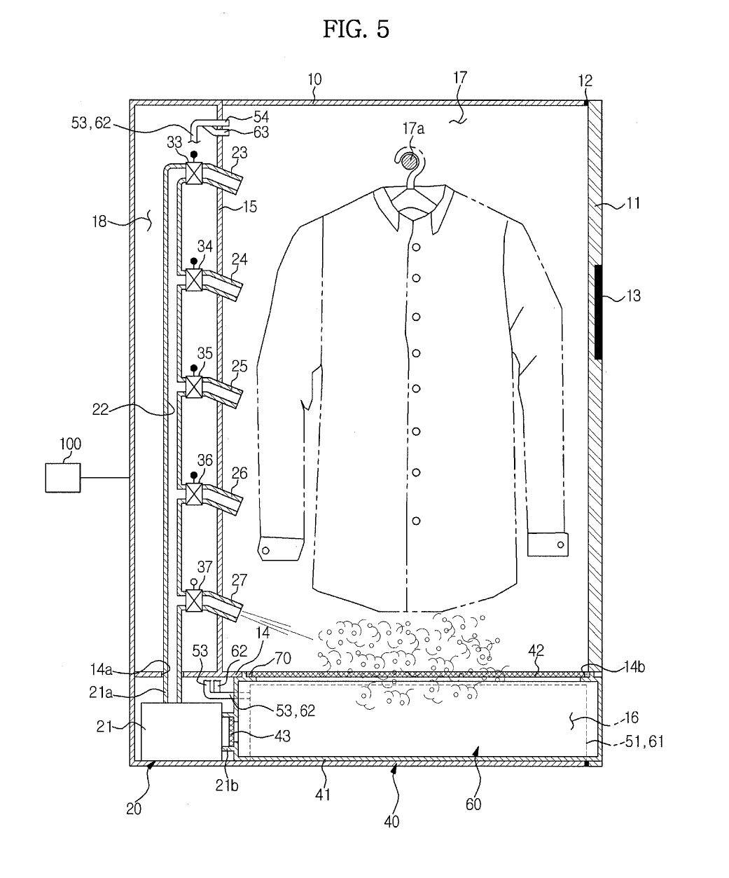

FIG. 3 is a view illustrating the early operation of the refresh washing machine according to the embodiment of the present disclosure, FIG. 4 is a view illustrating the middle operation of the refresh washing machine according to the embodiment of the present disclosure, and FIG. 5 is a view illustrating the final operation of the refresh washing machine according to the embodiment of the present disclosure.

As shown in FIGS. 1 to 5, a user opens the door 11 and puts clothes in the clothes receiving compartment 17 of the cabinet 10. Subsequently, the user closes the door 11 and presses a start button of the display 13 to drive the refresh washing machine.

The controller 100 sequentially opens the opening and closing valves 33 to 37 to spray air into the clothes receiving compartment 17 so that foreign matter, such as dust attached to the clothes, is separated from the clothes.

More specifically, the controller 100 first opens the first opening and closing valve 33 disposed at the uppermost side of the second partition 15 so that air is sprayed from the first nozzle 23. At this time, the other opening and closing valves 34 to 37 remain closed. Since the first nozzle 23 is inclined downward, air is sprayed downward from the first nozzle 23. Consequently, foreign matter separated from the clothes by the air sprayed from the first nozzle 23 moves downward.

Subsequently, the controller 100 opens the second opening and closing valve 34 so that air is sprayed from the second nozzle 24. At this time, the other opening and closing valves 33, 35, 36 and 37 remain closed. Since the second nozzle 24 is also inclined downward, air is sprayed downward from the second nozzle 24. Consequently, foreign matter separated from the clothes by the air sprayed from the second nozzle 24 moves downward. Also, the foreign matter being moved downward by the first nozzle 23 is further moved downward by the air sprayed from the second nozzle 24.

In the same manner, the controller 100 sequentially opens the third opening and closing valve 35 and the fourth opening and closing valve 36 so that air is sprayed from the third nozzle 25 and the fourth nozzle 26. The foreign matter is further moved to the lower side of the clothes receiving compartment 17 by the third nozzle 25 and the fourth nozzle 26.

Subsequently, the controller 100 opens the fifth opening and closing valve 37 so that air is sprayed from the fifth nozzle 27. At this time, the other opening and closing valves 33 to 36 remain closed. Since the fifth nozzle 27 is also inclined downward, air is sprayed downward from the fifth nozzle 27. Consequently, foreign matter separated from the clothes by the air sprayed from the fifth nozzle 27 moves downward. The foreign matter separated from the clothes by the nozzles 23 to 26 also moves downward. Finally, the foreign matter is stored in the dust tank 41 through the exhaust port 14b.

Meanwhile, the dust sensor 70 measures an amount of dust passing through the exhaust port 14b. The dust sensor 70 provides a dust measurement value to the controller 100. The controller 100 compares the dust measurement value with a reference value to adjust spray pressure or spray frequency of air sprayed from the spray nozzles 23 to 27. That is, when the dust measurement value exceeds the reference value, the controller 100 may increase the air spray pressure or the air spray frequency. On the other hand, when the dust measurement value is less than the reference value, the controller 100 may decrease the air spray pressure or the air spray frequency.

Subsequently, steam is supplied into clothes receiving compartment 17 using the steam supply unit 50. The steam serves to steam dry and sterilize the clothes.

Also, an aromatic, such as a fabric deodorizer, is sprayed into the clothes receiving compartment 17 using the aromatic supply unit 60. The aromatic removes unpleasant smells from the clothes receiving compartment 17 and provides fragrance to the clothes receiving compartment 17.

Also, moisture is removed from the clothes receiving compartment 17 using the dehumidification unit (not shown). Since the moisture is removed from the clothes, the clothes may be pressed flat.

In this embodiment, the nozzles are disposed from the upper side to the lower side of to the first partition 14 one by one for the convenience of description. In another embodiment, two or more nozzles may be disposed at the same height as the first partition 14, and the two or more nozzles may be simultaneously controlled.

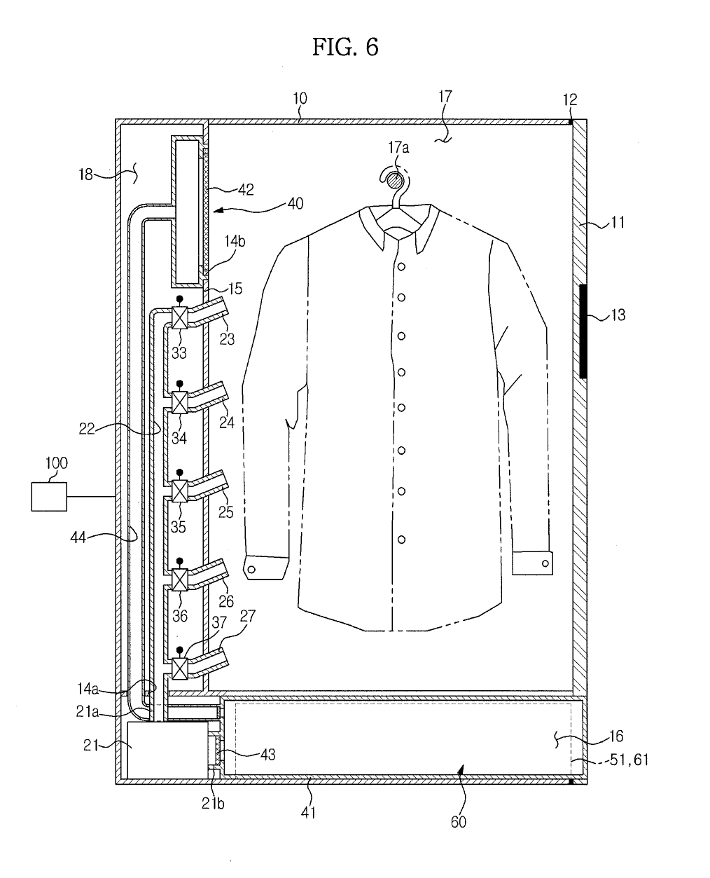

FIG. 6 is a sectional view illustrating the internal structure of a refresh washing machine according to another embodiment of the present disclosure.

As shown in FIG. 6, the refresh washing machine may include a cabinet 10, an air supply unit 20, a dust separation unit 40, a steam supply unit 50, an aromatic supply unit 60 and a dehumidification unit (not shown). Most of these components are identical to those of the refresh washing machine described with reference to FIGS. 1 to 5. Hereinafter, only components of this embodiment different from those of the previous embodiment will be described.

An exhaust port 14b is provided at the upper side of a second partition 15. An exhaust duct 44 is connected between the exhaust port 14b and a dust tank 41. Foreign matter, such as dust, having passed through the exhaust port 14b, moves to the dust tank 41 via the exhaust duct 44.

A plurality of nozzles 23 to 27 is mounted at the second partition 15 so that at least a portion of each of the nozzles 23 to 27 is exposed in a clothes receiving compartment 17. The nozzles 23 to 27 are upwardly inclined to a door 11. Consequently, air is sprayed upward from the nozzles 23 to 27 in an inclined state.

A plurality of opening and closing valves 33 to 37 allows air sprayed from the nozzles 23 to 27 to flow therethrough and interrupts such flow of air. A controller 100 controls the opening and closing valves 33 to 37 so that the nozzles 23 to 27 are sequentially operated. That is, air is sequentially sprayed from the nozzles 23 to 27. For example, air is first sprayed from the fifth nozzle 27 disposed at the lowermost side of a first partition 14, air is sprayed from the fourth nozzle 26 above the fifth nozzle 27, the third nozzle 25 above the fourth nozzle 26, the second nozzle 24 above the third nozzle 25 in order, and air is finally sprayed from the first nozzle 23 disposed at the uppermost side of the first partition 14.

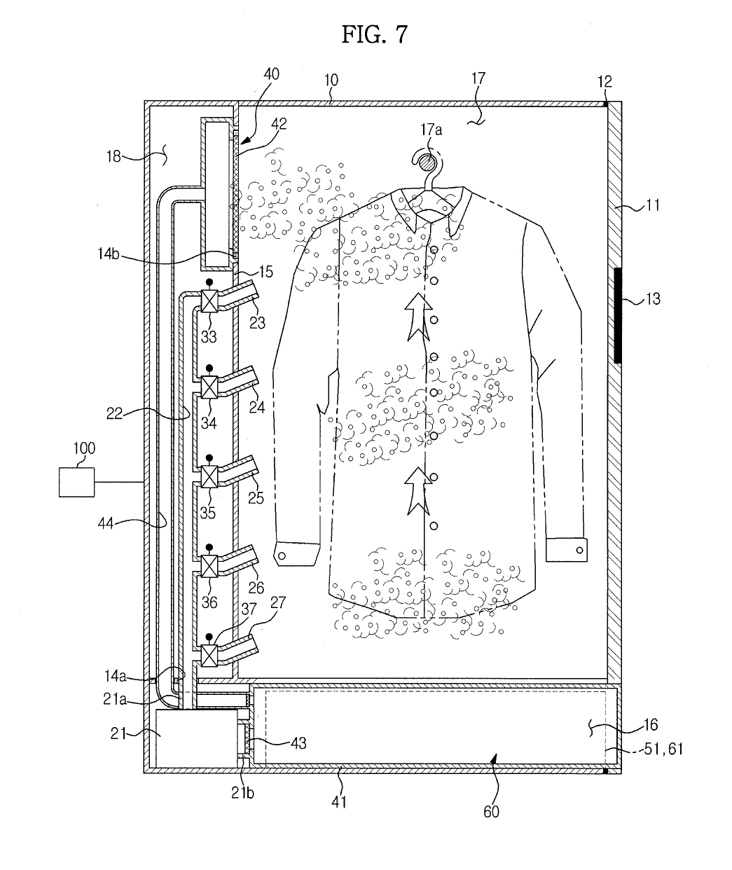

FIG. 7 is a view illustrating a series of operations of the refresh washing machine according to the embodiment of the present disclosure.

As shown in FIGS. 6 and 7, the controller 100 sequentially opens the opening and closing valves 33 to 37 to spray air into the clothes receiving compartment 17 so that foreign matter, such as dust attached to the clothes, is separated from the clothes.

First, the controller 100 first opens the fifth opening and closing valve 37 disposed at the lowermost side of the second partition 15 so that air is sprayed from the fifth nozzle 27. At this time, the other opening and closing valves 33 to 36 remain closed. Since the fifth nozzle 27 is inclined upward, air is sprayed upward from the fifth nozzle 27. Consequently, foreign matter separated from the clothes by the air sprayed from the fifth nozzle 27 moves upward.

Subsequently, the controller 100 opens the fourth opening and closing valve 36 so that air is sprayed from the fourth nozzle 26. At this time, the other opening and closing valves 33, 34, 35 and 37 remain closed. Since the fourth nozzle 26 is also inclined upward, air is sprayed upward from the fourth nozzle 26. Consequently, foreign matter separated from the clothes by the air sprayed from the fourth nozzle 26 moves upward. Also, the foreign matter being moved upward by the fifth nozzle 27 is further moved upward by the air sprayed from the fourth nozzle 26.

In the same manner, the controller 100 sequentially opens the third opening and closing valve 35 and the second opening and closing valve 34 so that air is sprayed from the third nozzle 25 and the second nozzle 24. The foreign matter is further moved to the upper side of the clothes receiving compartment 17 by the third nozzle 25 and the second nozzle 24.

Subsequently, the controller 100 opens the first opening and closing valve 337 so that air is sprayed from the first nozzle 23. At this time, the other opening and closing valves 34 to 37 remain closed. Since the first nozzle 23 is also inclined upward, air is sprayed upward from the first nozzle 23. Consequently, foreign matter separated from the clothes by the air sprayed from the first nozzle 23 moves upward. The foreign matter separated from the clothes by the nozzles 243 to 27 also moves upward. Finally, the foreign matter is stored in the dust tank 41 via the exhaust duct 44 through the exhaust port 14b disposed at the upper side of the second partition 15.

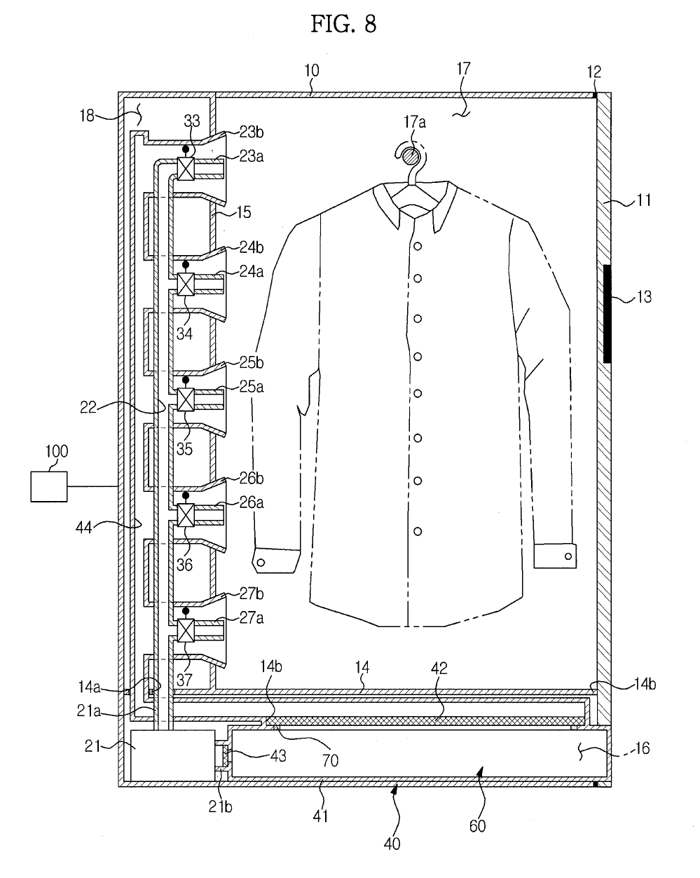

FIG. 8 is a sectional view illustrating the internal structure of a refresh washing machine according to a further embodiment of the present disclosure.

As shown in FIG. 8, refresh washing machine may include a cabinet 10, an air supply unit 20, a dust separation unit 40, a steam supply unit 50, an aromatic supply unit 60 and a dehumidification unit (not shown). Most of these components are identical to those of the refresh washing machine described with reference to FIGS. 1 to 5. Hereinafter, only components of this embodiment different from those of the previous embodiment will be described.

A first partition 14 of the cabinet 10 is mounted in the lateral direction of the cabinet 10 to partition the interior of the cabinet 10 in the vertical direction. A machine compartment 16 is provided at the lower side of the cabinet 10. An air pump 21, a dust tank 41, a water tank 51 and an aromatic tank 61 are mounted in the machine compartment 16.

A second partition 15 of the cabinet 15 is mounted in the vertical direction of the cabinet 10 to partition the interior of the cabinet 10 in the horizontal direction. A duct compartment 18 is provided at the left side of the second partition 15, and a clothes receiving compartment 17 is provided at the right side of the second partition 15. A spray duct 22 and an exhaust duct 44 are mounted in the duct compartment 18. The spray duct 22 and the exhaust duct 44 have branches corresponding to a plurality of nozzles 23 to 27.

The nozzles 23 to 27 are mounted at the second partition 15 so that at least a portion of each of the nozzles 23 to 27 is exposed in the clothes receiving compartment 17. The nozzles 23 to 27 may include spray nozzles 23a to 27a and exhaust nozzles 23b to 27b. The exhaust nozzles 23b to 27b are located so as to surround the outer circumferences of the respective spray nozzles 23a to 27a. The spray nozzles 23a to 27a are connected to the spray duct 22, and the exhaust nozzles 23b to 27b are connected to the exhaust duct 44.

A plurality of opening and closing valves 33 to 37 allows air sprayed from the spray nozzles 23a to 27a to flow therethrough and interrupts such flow of air. A controller 100 controls the opening and closing valves 33 to 37 so that the spray nozzles 23a to 27a are operated one after another. That is, when air is sprayed from one of the spray nozzles 23a to 27a, air is not sprayed from the other spray nozzles. Also, air may be sprayed from an arbitrarily selected one of the spray nozzles. That is, the spray nozzles 23a to 27a may be sequentially operated in the upward direction or in the downward direction. Alternatively, the spray nozzles 23a to 27a may be randomly operated.

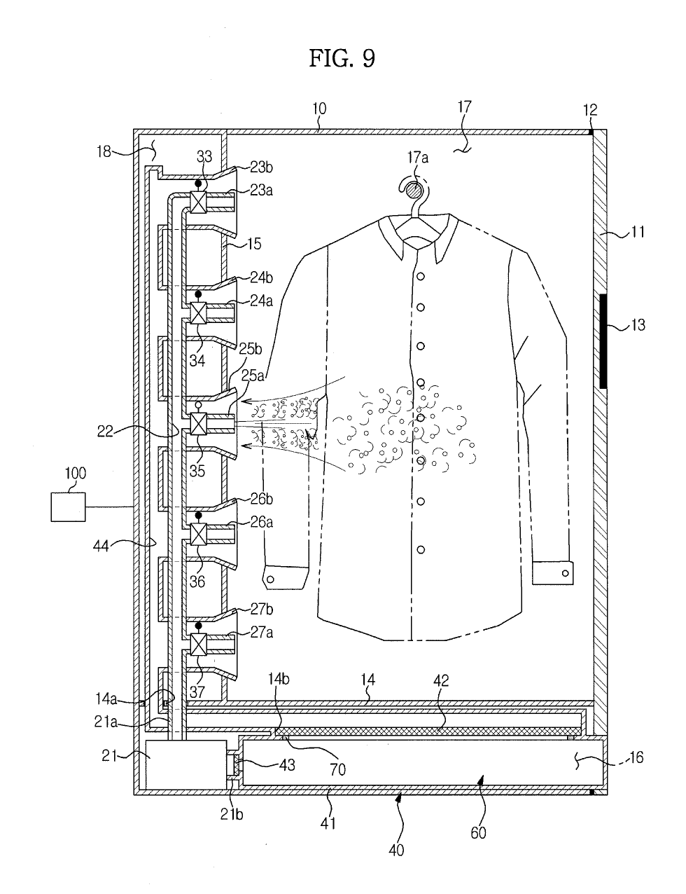

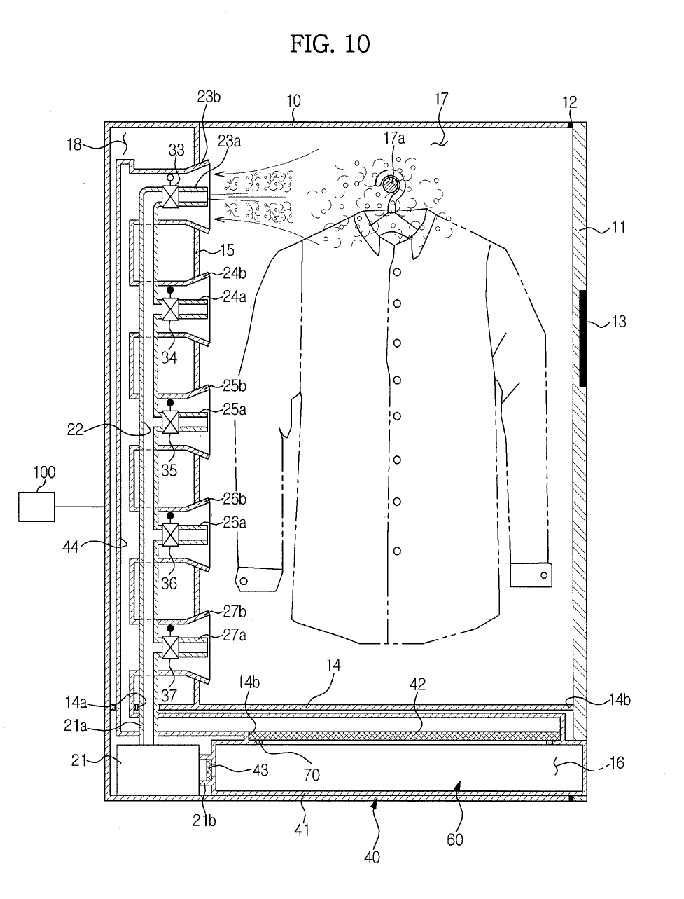

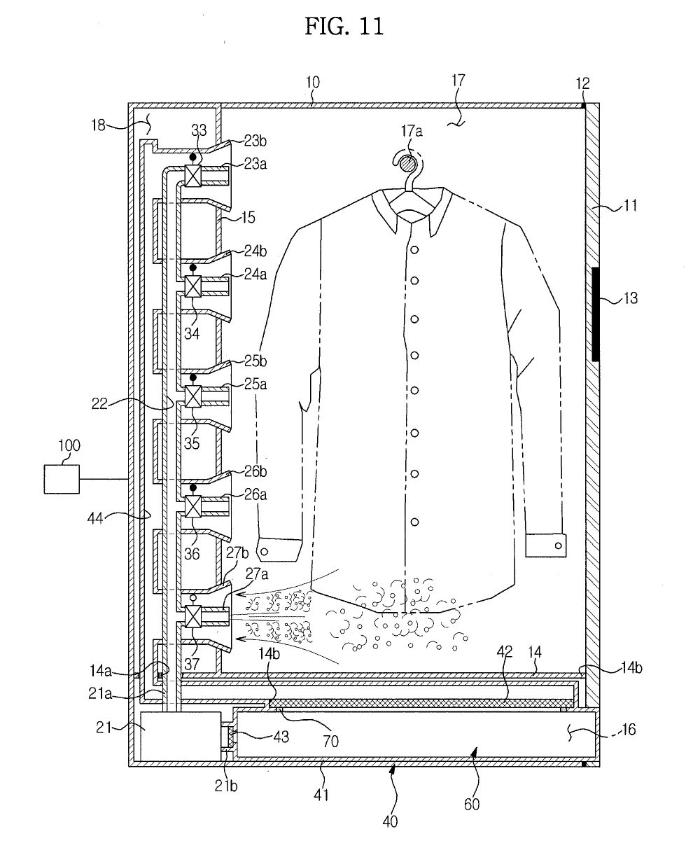

FIG. 9 is a view illustrating the early operation of the refresh washing machine according to the embodiment of the present disclosure, FIG. 10 is a view illustrating the middle operation of the refresh washing machine according to the embodiment of the present disclosure, and FIG. 11 is a perspective view illustrating view illustrating the final operation of the refresh washing machine according to the embodiment of the present disclosure.

As shown in FIGS. 8 to 11, the controller 100 opens the opening and closing valves 33 to 37 to spray air into the clothes receiving compartment 17 so that foreign matter, such as dust attached to the clothes, is separated from the clothes.

More specifically, the controller 100 first opens the third opening and closing valve 35 disposed at the middle of the second partition 15 so that air is sprayed from the third spray nozzle 25a. At this time, the other opening and closing valves 33, 34, 36 and 37 remain closed. Foreign matter is separated from the clothes by the air sprayed from the third spray nozzle 25a, and the floating foreign matter is suctioned through the third exhaust nozzle 25b. At this time, the foreign matter may be suctioned through the other exhaust nozzles 23b, 24b, 26b and 27b. An additional opening and closing valve may be mounted at the third exhaust nozzle 25b so that the foreign matter is suctioned through only the third exhaust nozzle 25b.

Subsequently, the controller 100 opens the first opening and closing valve 33 so that air is sprayed from the first spray nozzle 23a. At this time, the other opening and closing valves 34 to 37 remain closed. Foreign matter is separated from the clothes by the air sprayed from the first spray nozzle 23a, and the floating foreign matter may be suctioned through the exhaust nozzles 23b to 27b.

Subsequently, the controller 100 opens the fifth opening and closing valve 37 so that air is sprayed from the first spray nozzle 27a. At this time, the other opening and closing valves 33 to 36 remain closed. Foreign matter is separated from the clothes by the air sprayed from the fifth spray nozzle 27a, and the floating foreign matter may be suctioned through the exhaust nozzles 23b to 27b.

In the same manner, the controller 100 opens the second opening and closing valve 34 and the fourth opening and closing valve 36 so that air is sprayed from the second spray nozzle 24a and the fourth spray nozzle 26a. Floating foreign matter, separated from the clothes by the sprayed air, may be suctioned through the exhaust nozzles 23b to 27b.

In this way, the controller 100 randomly opens and closes the opening and closing valves 33 to 37 so that the spray nozzles 23a to 27a are operated. In the refresh washing machine shown in FIGS. 1 to 7, the opening and closing valves 33 to 37 are sequentially opened and closed in the downward direction or in the upward direction. In the refresh washing machine shown in FIGS. 8 to 11, on the other hand, one of the opening and closing valves 33 to 37 is randomly opened and closed.

The foreign matter suctioned through the exhaust nozzles 23b to 27b moves to the dust tank 41 via the exhaust duct 44 and is stored in the dust tank 41. Also, a dust sensor 70 may be mounted at the exhaust duct 44 or at the exhaust nozzles 23b to 27b. The dust sensor 70 measures an amount of dust passing through the exhaust duct 44 or the exhaust nozzles 23b to 27b. The dust sensor 70 provides a dust measurement value to the controller 100. The controller 100 compares the dust measurement value with a reference value to adjust spray pressure or spray frequency of air sprayed from the spray nozzles 23a to 27a. That is, when the dust measurement value exceeds the reference value, the controller 100 may increase the air spray pressure or the air spray frequency. On the other hand, when the dust measurement value is less than the reference value, the controller 100 may decrease the air spray pressure or the air spray frequency.

Subsequently, steam is supplied into clothes receiving compartment 17 using the steam supply unit 50. The steam serves to steam dry and sterilize the clothes.

Also, an aromatic, such as a fabric deodorizer, is sprayed into the clothes receiving compartment 17 using the aromatic supply unit 60. The aromatic removes unpleasant smells from the clothes receiving compartment 17 and provides fragrance to the clothes receiving compartment 17.

Also, moisture is removed from the clothes receiving compartment 17 using the dehumidification unit (not shown). Since the moisture is removed from the clothes, the clothes may be pressed flat.

As is apparent from the above description, the refresh washing machine washes clothes without using water and detergent, thereby reducing environmental pollution.

Also, clothes used on that day may be directly refreshed within a short time based on a daily care system.

Also, other clothes remain fresh through removal of moisture from the interior of a dress room or a wardrobe, thereby achieving easy care of clothes and lengthening life spans of the clothes.

Also, air spray pressure is increased while the size of the motor (or the pump) is decreased, thereby improving dust removal efficiency.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A refresh washing machine comprising:
a cabinet having a clothes receiving compartment;
a plurality of spray nozzles to spray air into the clothes receiving compartment of the cabinet;
a plurality of opening and closing valves to open and close the spray nozzles; and
a controller to open at least one of the opening and closing valves and close the other opening and closing valves so that air is sequentially sprayed from the spray nozzles.

2. The refresh washing machine according to claim 1, further comprising an exhaust port through which air is discharged from the clothes receiving compartment of the cabinet,
wherein the spray nozzles sequentially spray air from the spray nozzle most distant from the exhaust port to the spray nozzle closest to the exhaust port.

3. The refresh washing machine according to claim 2, wherein the spray nozzles sequentially spray air from the uppermost spray nozzle to the lowermost spray nozzle in a case in which the exhaust port is located at a lower side of the cabinet.

4. The refresh washing machine according to claim 3, wherein the spray nozzles are inclined downward.

5. The refresh washing machine according to claim 2, wherein the spray nozzles sequentially spray air from the lowermost spray nozzle to the uppermost spray nozzle in a case in which the exhaust port is located at an upper side of the cabinet.

6. The refresh washing machine according to claim 5, wherein the spray nozzles are inclined upward.

7. The refresh washing machine according to claim 2, further comprising a dust sensor to sense dust passing through the exhaust port,
wherein the controller adjusts spray pressure or spray frequency of air sprayed from the spray nozzles into the clothes receiving compartment based on information from the dust sensor.

8. The refresh washing machine according to claim 2, further comprising a dust tank connected to the exhaust port to store dust.

9. The refresh washing machine according to claim 8, further comprising an air pump connected to the dust tank to suction air.

10. The refresh washing machine according to claim 1, further comprising a spray duct connected to the nozzles and an air pump connected to the spray duct.

11. The refresh washing machine according to claim 1, further comprising a steam supply unit to supply steam into the clothes receiving compartment of the cabinet.

12. A refresh washing machine comprising:
a cabinet having a clothes receiving compartment; and
at least one nozzle exposed in the clothes receiving compartment of the cabinet, wherein the at least one nozzle comprises
a spray nozzle to spray air into the clothes receiving compartment of the cabinet; and
an exhaust nozzle to discharge air from the clothes receiving compartment of the cabinet.

13. The refresh washing machine according to claim 12, further comprising an opening and closing valve to open and close the spray nozzle.

14. The refresh washing machine according to claim 12, wherein the at least one nozzle comprises a plurality of nozzles.

15. The refresh washing machine according to claim 12, further comprising a spray duct connected to the spray nozzle and an air pump connected to the spray duct.

16. The refresh washing machine according to claim 12, further comprising an exhaust duct connected to the exhaust nozzle and a dust tank connected to the exhaust duct.

17. The refresh washing machine according to claim 12, wherein the exhaust nozzle surrounds an outer circumference of the spray nozzle.

18. A control method of a refresh washing machine comprising: a plurality of spray nozzles to spray air into a clothes receiving compartment; and a plurality of opening and closing valves to open and close the spray nozzles, the control method comprising:
controlling the opening and closing valves so that air is sequentially sprayed from the spray nozzles.

19. The control method according to claim 18, wherein the refresh washing machine further comprises an exhaust port through which air is discharged from the clothes receiving compartment; and a dust sensor to sense dust passing through the exhaust port, and
the control method further comprises adjusting spray pressure or spray frequency of air sprayed into the clothes receiving compartment based on information from the dust sensor.

20. The control method according to claim 19, further comprising increasing the air spray pressure or the air spray frequency when a dust measurement value measured by the dust sensor exceeds a reference value.

21. The control method according to claim 19, further comprising decreasing the air spray pressure or the air spray frequency when a dust measurement value measured by the dust sensor is less than a reference value.

22. The control method according to claim 18, wherein the refresh washing machine further comprises an exhaust port through which air is discharged from the clothes receiving compartment, and
the control method further comprises controlling the spray nozzles to sequentially spray air from the spray nozzle most distant from the exhaust port to the spray nozzle closest to the exhaust port.
